(19) United States
(12) Patent Application Publication
(10) Pub. No.: US 2022/0006361 A1
(43) Pub. Date: Jan. 6, 2022

(54) POSITIONING PRESSER AND POSITIONING STRUCTURE FOR RESOLVER STATOR

(71) Applicant: Jing-Jin Electric Technologies Co., Ltd., Beijing (CN)

(72) Inventors: Hongyang Zhao, Beijing (CN); Zhengqiang Pei, Beijing (CN)

(21) Appl. No.: 17/291,564

(22) PCT Filed: Jan. 20, 2021
(86) PCT No.: PCT/CN2021/072784

§ 371 Date: Jul. 9, 2021

(30) Foreign Application Priority Data
Apr. 7, 2020 (CN) 202020491701.0

(51) Int. Cl. H02K 11/21; H02K 1/12; H02K 5/04

(52) U.S. Cl. CPC H02K 11/21; H02K 5/04; H02K 1/12

(57) ABSTRACT

The present disclosure discloses a positioning presser and a positioning structure for a resolver stator, wherein the positioning presser is entirely of a round-ring shape, a main body of the positioning presser is provided with a stator pressing slot hole and/or a presser mounting slot hole, a positioning protrusion or groove is provided on an inner side of the positioning presser, and the positioning protrusion or groove matches with a groove or protrusion on the resolver stator, to position the resolver stator. The positioning presser according to the present disclosure can effectively reduce the difficulty in assembling of the revolver stator, which increases the efficiency in assembling, and reduces the defective percentage.

### TECHNICAL FIELD

The present disclosure relates to the technical field of electric-motor inspection, and particularly relates to a positioning presser and a positioning structure for a resolver stator.

### BACKGROUND

A revolver is one of electromagnetic sensors, is also referred to as a synchronous decomposer, and is a miniaturized alternating-current motor for measuring angles. A revolver is formed by a stator and a rotor, wherein generally the stator is fixed to the electric-motor end cover, and the rotor is fixed to the rotation shaft of the electric motor and rotates synchronously with the rotation shaft of the electric motor.

Currently, revolvers are used in the permanent-magnet synchronous motors of new-energy vehicles, for positioning the relative positions of the rotor magnetic poles and the phase windings of the stator. However, if the stator of the revolver cannot be effectively fixed or deviates due to vibration in the travelling of the car, that might cause erroneous feedback of the position of the rotor, thereby causing potential safety hazards such as vehicle out of control. Furthermore, conventional modes of fixing the resolver stator cannot ensure that the resolver stator of each of electric motors is in the same position, which results in that the zero-phase error between the electric motors is large, and the adjusting process is tedious.

### SUMMARY

Aiming at the above problems in the prior art, the present disclosure provides a positioning presser and a positioning structure for a resolver stator that can solve or at least partially solve the above technical problems.

In order to achieve the above object, the technical solutions of the present disclosure are realized as follows:

An aspect of the present disclosure provides a positioning presser for a resolver stator, wherein the positioning presser is entirely of a round-ring shape, a main body of the positioning presser is provided with a stator pressing slot hole and/or a presser mounting slot hole, a positioning protrusion or groove is provided on an inner side of the positioning presser, and the positioning protrusion or groove matches with a groove or protrusion on the resolver stator, to position the resolver stator.

Optionally, the stator pressing slot hole is a plurality of stator pressing slot holes, and the presser mounting slot hole is a plurality of presser mounting slot holes.

Optionally, center lines of a plurality of the stator pressing slot holes are on a same circumferential line, center lines of a plurality of the presser mounting slot holes are on a same circumferential line, and a diameter of the circumferential line of the stator pressing slot holes is less than a diameter of the circumferential line of the presser mounting slot holes.

Optionally, a resolver-stator pressing bolt or screw is provided on the stator pressing slot hole, a presser-mounting-slot-hole screw or bolt is provided on the presser mounting slot hole, and a diameter or inscribed circle of a nut of the resolver-stator pressing bolt or screw is greater than a diameter or inscribed circle of a nut of the presser-mounting-slot-hole screw or bolt.

Optionally, a cross section of the positioning protrusion or groove has any one of a rectangular shape, a triangular shape and a semicircular shape.

Optionally, the positioning presser is formed by stamping.

Optionally, the positioning presser is made from a carbon steel having a plasticity.

Optionally, the positioning presser is provided with a notch for accommodating a cable.

Another aspect of the present disclosure provides a positioning structure for a resolver stator, wherein the positioning structure comprises a resolver stator and an electric-motor end cover, the positioning structure further comprises the positioning presser of any one of the above items, the resolver stator is adjustably fixed to the electric-motor end cover via the positioning protrusion or groove of the positioning presser, and the resolver stator is provided with a groove or protrusion.

Optionally, a resolver-stator pressing bolt or screw is provided on the stator pressing slot hole, a presser-mounting-slot-hole screw or bolt is provided on the presser mounting slot hole, the resolver-stator pressing bolt or screw is for pressing the resolver stator on the electric-motor end cover, and the presser-mounting-slot-hole screw or bolt is for mounting and fixing the positioning presser to the electric-motor end cover.

The above technical solutions of the present disclosure can obtain the following advantageous effects:

The present disclosure can effectively reduce the difficulty in assembling, which increases the efficiency in assembling, and facilitates to reduce the defective percentage. In the mass production of the electric motor, the electrical-angle zero points of the electric motors can be made the same, which improves the uniformity of the assembling quality of electric motors of the same model.

### BRIEF DESCRIPTION OF THE DRAWINGS

FIG. 1 is a schematic structural diagram of the installation of the resolver stator according to an embodiment of the present disclosure; and

FIG. 2 is a schematic structural diagram of the positioning presser for a resolver stator according to an embodiment of the present disclosure.

In the drawings: 1. resolver-stator pressing bolt or screw; 2. presser-mounting-slot-hole screw or bolt; 3. positioning presser for a resolver stator; 4. resolver stator; 5. electric-motor end cover; 31. positioning protrusion; 32. stator pressing slot hole; and 33. presser mounting slot hole.

### DETAILED DESCRIPTION

In order to make the objects, the technical solutions and the advantages of the present disclosure clearer, the technical solutions of the present disclosure will be clearly and completely described below with reference to the particular embodiments and the corresponding drawings of the present disclosure. Apparently, the described embodiments are merely certain embodiments of the present disclosure, rather than all of the embodiments. All of the other embodiments that a person skilled in the art can obtain on the basis of the embodiments in the present disclosure without paying creative work will fall within the protection scope of the present disclosure.

### The First Embodiment

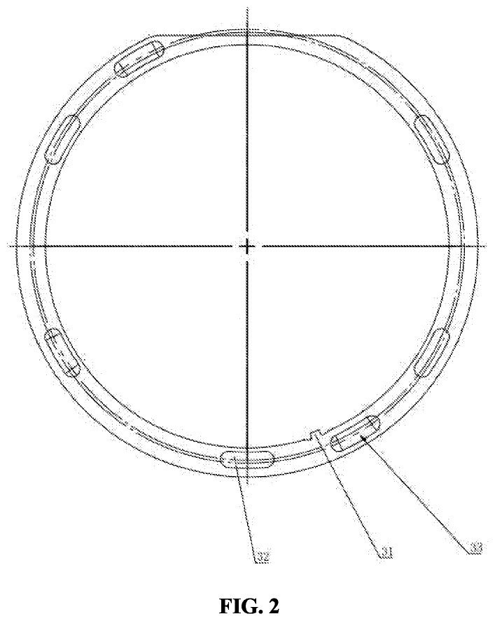

As shown in FIG. 2, the first embodiment of the present disclosure discloses a positioning presser for a resolver stator. The positioning presser 3 is entirely of a round-ring shape. The main body of the positioning presser 3 is provided with a stator pressing slot hole 32 and/or a presser mounting slot hole 33. The stator pressing slot hole 32 and/or presser mounting slot hole 33 can realize the fixing of the positioning presser 3 and the resolver stator 4 to the electric-motor end cover 5. The slot holes facilitate the adjustment on positions during the fixing. Bolts or screws are provided in the slot holes, to realize the pressing or installation positioning of the resolver stator or the positioning presser.

A positioning protrusion 31 or groove is provided on the inner side of the positioning presser 3. The positioning protrusion 31 or groove matches with a groove or protrusion on the resolver stator 4, to position the resolver stator 4, during which the position of the resolver stator is changed by the rotary adjustment on the positioning presser 3.

The positioning presser 3 according to the present embodiment has a low difficulty in assembling, which can effectively increase the efficiency in assembling. The positioning presser 3 has a simple structure, which facilitates the production and facilitates to reduce the defective percentage. By positioning and installing by using the positioning presser 3 according to the present embodiment, it can be ensured that the resolver stator 4 of each of electric motors is in the same position, which effectively reduces the zero-phase error between the electric motors.

Optionally, the stator pressing slot hole 32 is a plurality of stator pressing slot holes, preferably 5, and the presser mounting slot hole 33 is a plurality of presser mounting slot holes, preferably 2. The stator pressing slot holes 32 and the presser mounting slot holes 33 are axially symmetric respectively, which enables the positioning presser 3 and the resolver stator 4 to bear force uniformly, to facilitate the installation and the fixing.

In a preferable embodiment, as can be seen from FIG. 2, the center lines of the plurality of stator pressing slot holes 32 are on the same circumferential line, and the center lines of the plurality of presser mounting slot holes 33 are on the same circumferential line, which facilitates the evenness of the borne forces. The diameter of the circumferential line of the stator pressing slot holes 32 is less than the diameter of the circumferential line of the presser mounting slot holes 33.

In an embodiment, a resolver-stator pressing bolt or screw 1 is provided in the stator pressing slot hole 32, a presser-mounting-slot-hole screw or bolt 2 is provided in the presser mounting slot hole 33, and the diameter or inscribed circle of the nut of the resolver-stator pressing bolt or screw 1 is greater than the diameter or inscribed circle of the nut of the presser-mounting-slot-hole screw or bolt 2, which facilitates to firmly fix the resolver stator 4.

In a preferable embodiment, the cross section of the positioning protrusion 31 or groove has any one of a rectangular shape, a triangular shape and a semicircular shape. Certainly, the cross section of the positioning protrusion 31 or groove may also be of another shape that can serve to fix, such as a square-shape or a trapezoidal shape.

In an embodiment, the positioning presser 3 is formed by stamping. The positioning presser 3 may also be formed by cutting, or formed by another mode.

Preferably, the positioning presser 3 is made from a carbon steel having a plasticity, or another metal material having a plasticity.

In an embodiment, the positioning presser 3 is provided with a notch for accommodating a cable. The cable may pass through the notch, which facilitates wiring in the installation process of the revolver.

In conclusion, the present disclosure discloses a positioning presser for a resolver stator, wherein the positioning presser is entirely of a round-ring shape, a main body of the positioning presser is provided with a stator pressing slot hole and/or a presser mounting slot hole, a positioning protrusion or groove is provided on an inner side of the positioning presser, and the positioning protrusion or groove matches with a groove or protrusion on the resolver stator, to position the resolver stator. The positioning presser according to the present disclosure can effectively reduce the difficulty in assembling of the revolver stator, which increases the efficiency in assembling, and reduces the defective percentage of the product.

### The Second Embodiment

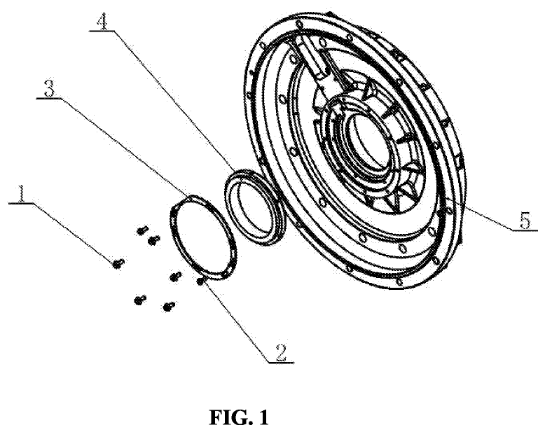

The second embodiment of the present disclosure discloses a positioning structure for a resolver stator. As shown in FIG. 1, the positioning structure comprises a resolver stator 4 and an electric-motor end cover 5. The positioning structure further comprises the positioning presser 3 of any one of the above items. The resolver stator 4 is adjustably fixed to the electric-motor end cover 5 via the positioning protrusion 31 or groove of the positioning presser 3. The resolver stator 4 is provided with a groove or protrusion. The positioning protrusion 31 or groove on the positioning presser 3 matches with the groove or protrusion on the resolver stator 4, which facilitates the positioning and fixing between the positioning presser 3 and the resolver stator 4.

By using the positioning structure according to the present embodiment, in the mass production of the electric motor, the electrical-angle zero points of the electric motors can be made the same, which improves the uniformity of the assembling quality of electric motors of the same model.

In an embodiment, a resolver-stator pressing bolt or screw 1 is provided in the stator pressing slot hole 32, a presser-mounting-slot-hole screw or bolt 2 is provided in the presser mounting slot hole 33, the resolver-stator pressing bolt or screw 1 is for pressing the resolver stator 4 on the electric-motor end cover 5, and the presser-mounting-slot-hole screw or bolt 2 is for mounting and fixing the positioning presser 3 to the electric-motor end cover 5.

The above are merely particular embodiments of the present disclosure. By the teaching of the present disclosure, a person skilled in the art can make other modifications or variations on the basis of the above embodiments. A person skilled in the art should understand that the above particular descriptions are merely for the purpose of better interpreting the present disclosure, and the protection scope of the present disclosure should be subject to the protection scope of the claims.

1. A positioning presser for a resolver stator, wherein the positioning presser is entirely of a round-ring shape, a main body of the positioning presser is provided with a stator pressing slot hole and/or a presser mounting slot hole, a positioning protrusion or groove is provided on an inner side of the positioning presser, and the positioning protrusion or groove matches with a groove or protrusion on the resolver stator, to position the resolver stator.

2. The positioning presser according to claim 1, wherein the stator pressing slot hole is a plurality of stator pressing slot holes, and the presser mounting slot hole is a plurality of presser mounting slot holes.

3. The positioning presser according to claim 2, wherein center lines of the plurality of stator pressing slot holes are on a same circumferential line, center lines of the plurality of presser mounting slot holes are on a same circumferential line, and a diameter of the circumferential line of the stator pressing slot holes is less than a diameter of the circumferential line of the presser mounting slot holes.

4. The positioning presser according to claim 1, wherein a resolver-stator pressing bolt or screw is provided in the stator pressing slot hole, a presser-mounting-slot-hole screw or bolt is provided in the presser mounting slot hole, and a diameter or inscribed circle of a nut of the resolver-stator pressing bolt or screw is greater than a diameter or inscribed circle of a nut of the presser-mounting-slot-hole screw or bolt.

5. The positioning presser according to claim 1, wherein a cross section of the positioning protrusion or groove has any one of a rectangular shape, a triangular shape and a semicircular shape.

6. The positioning presser according to claim 2, wherein the positioning presser is formed by stamping.

7. The positioning presser according to claim 1, wherein the positioning presser is made from a carbon steel having a plasticity.

8. The positioning presser according to claim 1, wherein the positioning presser is provided with a notch for accommodating a cable.

9. A positioning structure for a resolver stator, wherein the positioning structure comprises a resolver stator and an electric-motor end cover, the positioning structure further comprises the positioning presser according to claim 1, the resolver stator is adjustably fixed to the electric-motor end cover via the positioning protrusion or groove of the positioning presser, and the resolver stator is provided with a groove or protrusion.

10. The positioning structure according to claim 9, wherein a resolver-stator pressing bolt or screw is provided in the stator pressing slot hole, a presser-mounting-slot-hole screw or bolt is provided in the presser mounting slot hole, the resolver-stator pressing bolt or screw is for pressing the resolver stator on the electric-motor end cover, and the presser-mounting-slot-hole screw or bolt is for mounting and fixing the positioning presser to the electric-motor end cover.

11. A positioning structure for a resolver stator, wherein the positioning structure comprises a resolver stator and an electric-motor end cover, the positioning structure further comprises the positioning presser according to claim 2, the resolver stator is adjustably fixed to the electric-motor end cover via the positioning protrusion or groove of the positioning presser, and the resolver stator is provided with a groove or protrusion.

12. A positioning structure for a resolver stator, wherein the positioning structure comprises a resolver stator and an electric-motor end cover, the positioning structure further comprises the positioning presser according to claim 3, the resolver stator is adjustably fixed to the electric-motor end cover via the positioning protrusion or groove of the positioning presser, and the resolver stator is provided with a groove or protrusion.

13. A positioning structure for a resolver stator, wherein the positioning structure comprises a resolver stator and an electric-motor end cover, the positioning structure further comprises the positioning presser according to claim 4, the resolver stator is adjustably fixed to the electric-motor end cover via the positioning protrusion or groove of the positioning presser, and the resolver stator is provided with a groove or protrusion.

14. A positioning structure for a resolver stator, wherein the positioning structure comprises a resolver stator and an electric-motor end cover, the positioning structure further comprises the positioning presser according to claim 5, the resolver stator is adjustably fixed to the electric-motor end cover via the positioning protrusion or groove of the positioning presser, and the resolver stator is provided with a groove or protrusion.

15. A positioning structure for a resolver stator, wherein the positioning structure comprises a resolver stator and an electric-motor end cover, the positioning structure further comprises the positioning presser according to claim 6, the resolver stator is adjustably fixed to the electric-motor end cover via the positioning protrusion or groove of the positioning presser, and the resolver stator is provided with a groove or protrusion.

16. A positioning structure for a resolver stator, wherein the positioning structure comprises a resolver stator and an electric-motor end cover, the positioning structure further comprises the positioning presser according to claim 7, the resolver stator is adjustably fixed to the electric-motor end cover via the positioning protrusion or groove of the positioning presser, and the resolver stator is provided with a groove or protrusion.

17. A positioning structure for a resolver stator, wherein the positioning structure comprises a resolver stator and an electric-motor end cover, the positioning structure further comprises the positioning presser according to claim 8, the resolver stator is adjustably fixed to the electric-motor end cover via the positioning protrusion or groove of the positioning presser, and the resolver stator is provided with a groove or protrusion.
